(19) United States
(12) Patent Application Publication
(10) Pub. No.: US 2016/0117463 A1
(43) Pub. Date: Apr. 28, 2016

(54) MEDICAL SENSOR PROVIDING AUDIO COMMUNICATION TONES

(71) Applicant: PRESIDENT AND FELLOWS OF HARVARD COLLEGE, Cambridge, MA (US)

(72) Inventors: Alex Nemiroski, Cambridge, MA (US); Elizabeth Jane Maxwell, Cambridge, MA (US); George M. Whitesides, Cambridge, MA (US); Dionysios C. Christodouleas, Cambridge, MA (US); Jonathan W. Hennek, Cambridge, MA (US); Ashok Ashwin Kumar, Cambridge, MA (US)

(21) Appl. No.: 14/895,441

(22) PCT Filed: Jun. 4, 2014
(86) PCT No.: PCT/US14/40919

§ 371 Date: Dec. 2, 2015

Related U.S. Application Data
(60) Provisional application No. 61/830,868, filed on Jun. 4, 2013.
(60) Provisional application No. 61/925,032, filed on Jan. 8, 2014.

(51) Int. Cl. G06F 19/00; H04Q 9/00; H04L 29/08; H04W 88/04

(52) U.S. Cl. CPC G06F 19/3418; H04W 88/04; H04Q 9/00; H04L 67/12; H04Q 2209/40

(57) ABSTRACT

A device includes a sensor to detect a parameter related to a diagnostic test. A controller is coupled to the sensor to receive sensed information from the sensor and generate data representative of the parameter. A tone generator encodes the data and provides audio tones to couple to a communication device.

### RELATED APPLICATION

This application claims priority to U.S. Provisional Application Ser. No. 61/830,868, filed Jun. 4, 2013, and to U.S. Provisional Application Ser. No. 61/925,032, filed Jan. 8, 2014, both of which are incorporated herein by reference in their entireties.

### BACKGROUND

Large segments of the population in the developing world, particularly in rural areas, have little or no access to the modem diagnostic tools and medical expertise that are commonly available in the developed world. The isolation of rural communities makes it difficult to track and respond to emerging problems such as malnutrition, spread of disease, and poor water quality. Low-cost diagnostic devices, such as lateral flow immunoassays and hand-held glucometers, enable diagnosis or monitoring of certain conditions at the point of care, but they are typically limited in function and do not have the connectivity necessary to interface with broader medical and public health infrastructures.

### SUMMARY

A device includes a sensor to detect a parameter related to a diagnostic test. A controller is coupled to the sensor to receive sensed information from the sensor and generate data representative of the parameter. A tone generator encodes the data and provides audio tones to couple to a communication device.

In one embodiment, a method includes receiving data representative of a parameter corresponding to a diagnostic test, encoding the data into audio tones, playing the audio tones in a manner than can be received by a mobile telephone, and repeating playing the audio tones until an acknowledgement is received.

A further method includes receiving audio tones representative of encoded data corresponding to a value of a parameter sensed in a diagnostic test, wherein the encoded data includes an error code, decoding the received audio tones into digits corresponding to the value of the sensed parameter, applying the error code to check the validity of the decoded data, and playing an acknowledgement tone when the decoded data is valid.

### BRIEF DESCRIPTION OF THE DRAWINGS

FIG. 1A is a block diagram of a medical testing device coupled to a cellular phone according to an example embodiment.

FIG. 1B is a block diagram of a medical testing device coupled to a network according to an example embodiment.

FIG. 2A is a detailed block diagram of a medical testing device illustrating interconnections according to an example embodiment.

FIG. 2B is a block diagram of a potentiostat of the testing device of FIG. 2A according to an example embodiment.

FIG. 2C is a block diagram of an alternative potentiostat of the testing device of FIG. 2A according to an example embodiment.

FIG. 3A is a timing diagram of cyclic voltammetry performed by a medical testing device coupled to a cellular phone according to an example embodiment.

FIG. 3B is a timing diagram of chronoamperometry performed by a medical testing device coupled to a cellular phone according to an example embodiment.

FIG. 3C is a timing diagram of stripping voltammetry performed by a medical testing device coupled to a cellular phone according to an example embodiment.

FIG. 4 is a flowchart illustrating methods performed by a medical testing device, phone, and remote computer according to an example embodiment.

FIG. 5 is a graph illustrating an average current as a function of glucose concentration according to an example embodiment.

FIG. 6A is a graph illustrating a cyclic voltammagram according to an example embodiment.

FIG. 6B is a graph illustrating measured current versus time for an example chronoaperometry according to an example embodiment.

FIG. 6C is a graph illustrating differential-pulse and square-wave voltammagrams according to an example embodiment.

FIG. 6D is a graph illustrating detection of K⁺ and Na⁺ with potentiometry in an ionic strength adjuster according to an example embodiment.

FIG. 6E is a calibration plot of current versus concentration of glucose in assayed samples of human blood measured by chronoamperometry according to an example embodiment.

FIG. 6F is a calibration plot of peak current versus concentration of lead according to an example embodiment.

FIG. 6G is a graph illustrating detection of Na⁺ in assayed human urine control samples measured by potentiometry according to an example embodiment.

FIG. 6H is a calibration plot of current versus the concentration of PfHRP2 in PBS(1×) according to an example embodiment.

FIG. 6I is a plot of a received audio signal according to an example embodiment.

FIG. 6J is a graph illustrating an FFT of a packet demonstrating the presence of seven distinct frequency signals and the values to which they correspond according to an example embodiment.

FIG. 6K is a graph illustrating a decoded packet containing a sequence according to an example embodiment.

FIG. 6L is a plot illustrating an overall PSR versus symbol rate according to an example embodiment.

FIG. 6M is a plot illustrating PR versus symbol rate according to an example embodiment.

FIG. 6N is a plot illustrating the EPR versus the symbol rate according to an example embodiment.

FIG. 7A is a block flow illustration of a device taking a measurement and transmitting the measurement via a cellular phone according to an example embodiment.

FIG. 7B is an illustration of a remote system receiving a measurement via pulses transmitted by a cellular phone according to an example embodiment.

FIG. 7C is a series of screen shots illustrating sending and receipt of messages via a medical testing device coupled to a cellular phone according to an example embodiment.

FIG. 8 is a block diagram of electronic circuitry for implementing one or more devices according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A system comprises a simple, hand-held device for telemedicine that couples electrochemical and other medical related sensing to any mobile phone, including the low-end phones common to resource-limited settings. The device can perform a range of electrochemical measurements of parameter related to diagnostic tests using compatible electrochemical micro-paper-based analytical devices, and communicate the acquired results in real-time over any mobile phone network.

As an alternative to telemedicine protocols based on optical sensing of a colorimetric assay, this electrochemical device offers several advantages. The signal measured by the electrochemical test is not affected by the color of the sample, lighting conditions, or the presence particulate matter. The measured current or voltage can be transformed to a numeric output by simple electronics; (iii) the results of testing can be made “user-blind” in order to eliminate user bias, or if privacy is a concern.

Telemedicine allows patients and health care workers in distant locations to connect with medical personnel or public health systems not available locally. Over the last decade, the plummeting cost of low-end mobile phones and relative simplicity of installing and maintaining large area wireless networks has enabled the proliferation of mobile connectivity even in settings that lack traditional civic infrastructures, such as roads, pipes, and power lines.

Large segments of populations in the developing world are increasingly relying on low-end mobile phones for communication, news, banking, education, and health care. In this context, where traditional infrastructures have failed, telemedicine technologies that depend on mobile phones for connectivity have emerged as a vital component in the delivery of health-care and tracking of public health data.

The combination of diagnostic testing and telemedicine allows the results of testing to be transmitted wirelessly to a qualified specialist (or computer system) at a central location; this person (or computer) can interpret and archive the results, and transmit that information or instructions back to the user. Furthermore, access to the results of tests, when communicated to a central reporting center, enables public-health officials to recognize and respond to cases requiring special attention. This approach offers an attractive alternative to traditional health-care delivery.

Simple telemedical applications that rely on user entry by SMS messages or transmission of photographs of a test device are low throughput and susceptible to user error. The use of more sophisticated devices that allow diagnostic testing has been limited by the lack of advanced 3G/4G wireless networks. For example, it is estimated that, by 2016, sub-Saharan Africa (SSA) will have 75% market penetration for 2G voice and SMS networks but only 15% penetration for advanced 3G and 4G networks.

In India, broadband connectivity (3G and higher) is negligible in rural areas, which are home to 70 percent of the total population. Furthermore, these advanced devices typically require the purchase of a specific, expensive smartphone (e.g. the iPhone) with custom software and proprietary connectors.

Inexpensive phones offer fewer options for connecting to an outside device or accessory. Fortunately, the hands-free audio port appears to be a universal interface to any mobile phone, enabling even a low-end phone to function as a modem linking an external device to a remote facility through the 2G-voice network.

Data encoded into frequency-modulated signals can be transmitted directly to and from the external device, enhancing the sophistication of measurements that can be communicated over telemedical networks. Although noise and interference in the voice channel can degrade the quality of data transmitted by frequency modulation, devices have been developed to stream analog biometric signals (e.g. heart rate) for which timing is more important than accurate signal reconstruction. Analog modulation, however, is not appropriate for diagnostic assays that require the transmission of precise numeric data.

An approach relying digital modulation could compensate for low signal quality through error detection and therefore enable the transmission of data output by a diagnostic device.

Electrochemical sensors can be used to detect a range of important analytes (e.g. glucose, lactate, urea, heavy metals, biomarkers, etc.) using different pulse-sequences, while the required electronics can be assembled at low cost without sacrificing this versatility. Certainly, the global popularity of hand-held glucometers demonstrates that electrochemical readers can be made user friendly and scaled at a low cost (due to mass manufacturing) without compromising quantitative abilities.

Electrochemical measurements may utilize a potentiostat and two or three electrodes, which are in contact with the sample solution, to transduce a parameter such as the chemical properties of the sample into an electrical signal. A wide variety of analytes, ranging from metabolites, to enzymes, and metals, can be measured using different electrochemical methods.

For example, a hand-held glucometer measures a parameter comprising the concentration of glucose in blood by combining an enzymatic assay with electrochemical detection. The enzymatic assay uses glucose oxidase or glucose dehydrogenase to oxidize glucose and generate a reduced electrochemical mediator (ferrocyanide or pyrroloquinoline quinone, depending on the test). The glucometer then reoxidizes the electrochemical mediator by applying a fixed potential, and the resulting current correlates to the concentration of glucose in the sample. The assay, measurement, interpretation, and display are managed seamlessly by the glucometer. The user-friendliness and low cost (due to mass manufacturing) of these devices have contributed to their global popularity.

Expanded Electrochemical Testing with a Glucometer

Recently, simple and inexpensive chemical tests in the form of electrochemical micro-paper-based analytical devices have become available. These devices use paper that is patterned with hydrophobic barriers to guide fluid transport, and screen-printed electrodes that perform the electrochemical measurement. Some glucometers can quantify analytes, such as lactate, cholesterol, and ethanol when combined with an EμPAD that contains an enzyme that oxidizes an analyte of interest. At least one glucometer may be used as a detector for an aptamer-based assay, in which an analyte displaced DNA-conjugated invertase from a magnetic bead. Following removal of the beads, the released invertase catalyzed the conversion of sucrose to glucose, at a rate proportional to the concentration of analyte in the sample.

In one embodiment, a handheld device for telemedicine includes a potentiostat for measuring electrochemical assays on an EμPAD, and a microcontroller for applying potentials, acquiring data corresponding to sensed parameters, and interfacing to the audio port of a mobile phone. The device uses an audio-based algorithm to transmit digital data over any mobile voice network (2, 3, or 4G) using the audio port of any mobile phone (microphone). Frequency Shift Keying (FSK) may be used to encode binary data as a discrete series of audio tones. The audio tones may be transmitted over a wireless voice network. In one embodiment, the binary data comprises multiple digits, with each digit represented by a different audio tone or tones. The frequency of the tones may be different for each digit. Ten digits are used in one embodiment.

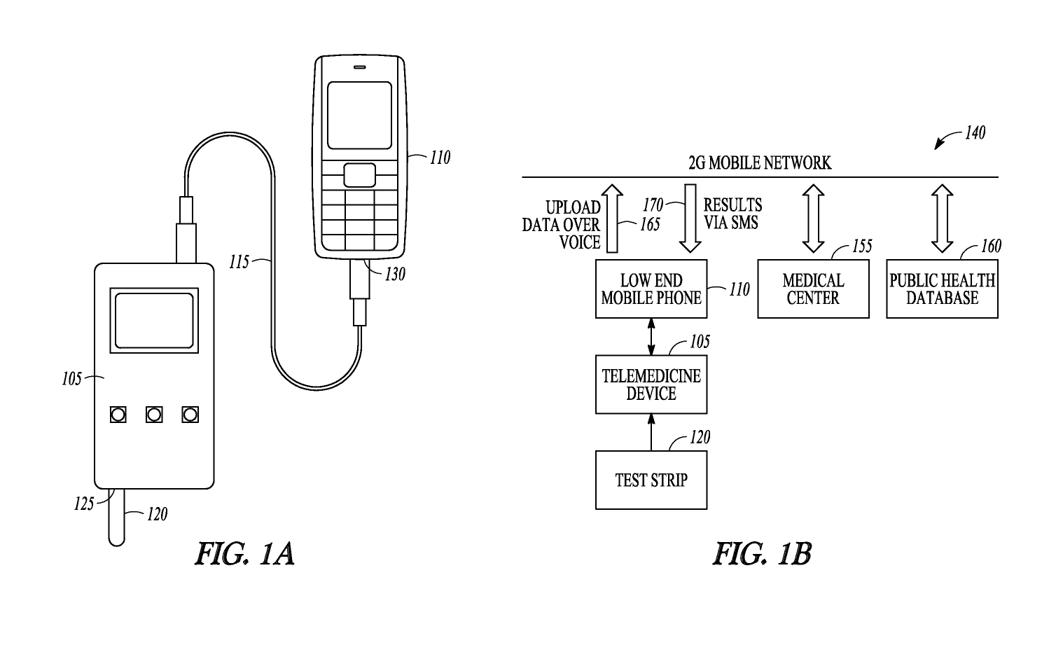

FIGS. 1A and 1B are diagrams of the device connected to a low-end mobile phone and the intended flow of information linking a point-of-care measurement and a remote medical facility. This point of care (POC) diagnostic tool can be produced at low cost and has the flexibility to perform many useful two- or three-electrode amperometric, coulometric, or potentiometric measurement, using applied voltages ranging from −3V to 3V, and under chronometric control.

FIG. 1A is an image of the telemedicine device 105, a low-end mobile phone 110, a standard audio cable 115, and a test strip 120. The audio cable 115 is coupled to an audio output port 125 of the telemedicine device 105 and to a microphone port 130 of the mobile phone 110, and is used to transmit audio signals to the mobile phone, which are then transmitted via a network in one embodiment. The network may be a voice network such as a 2G, 3G, or 4G mobile network or other mobile networks, or a data network in various embodiments.

FIG. 1B is a block schematic diagram 140 of the connections and flow of data via a network 150 from the device to a remote medical back end, such as a medical center 155 or a public health database 160 for example. Information from the phone to the network is indicated at 165 and may be a data over voice form of communication. Note that data in the form of SMS (short message service) 170 may also flow from the network 150 to the mobile phone 110 and back to the telemedicine device 105 to carry indications that data has been successfully received. A sensor in the telemedicine device in some embodiments includes electrochemical analysis sensors for the determination of glucose in blood by chronoamperometry, and for the determination of lead in drinking water by square wave voltammetry (SWV).

The telemedicine device 105, in combination with disposable paper-based test strips 120 (or commercial test-strips), is an inexpensive, versatile tool that provides a simple link between electrochemical assays and existing telecommunication technology available in the developing world.

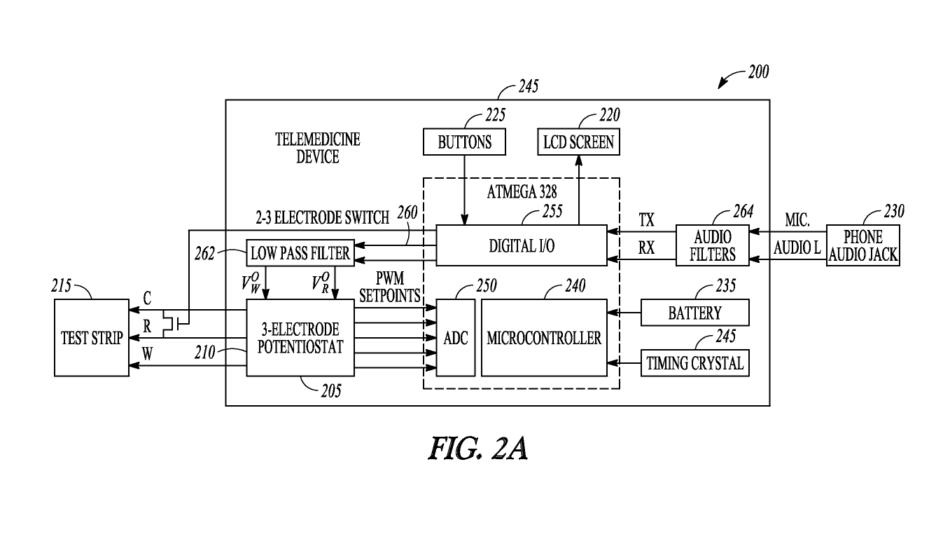

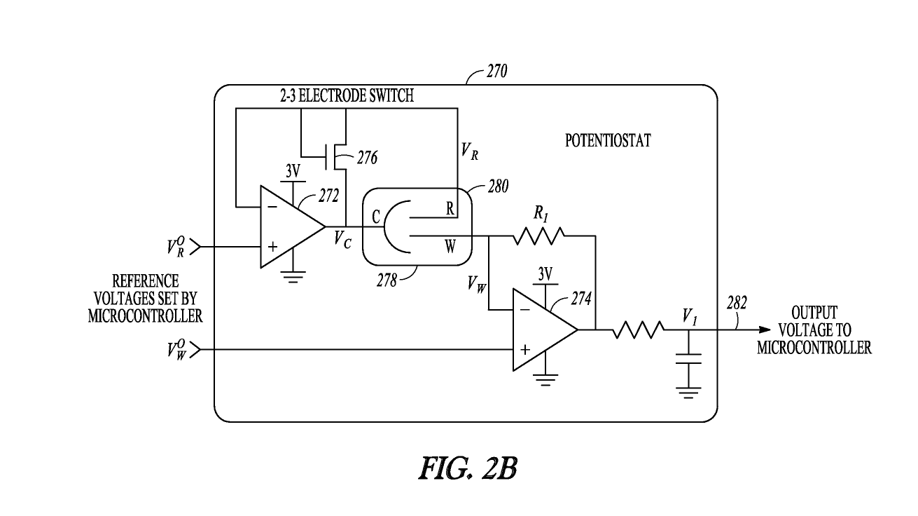

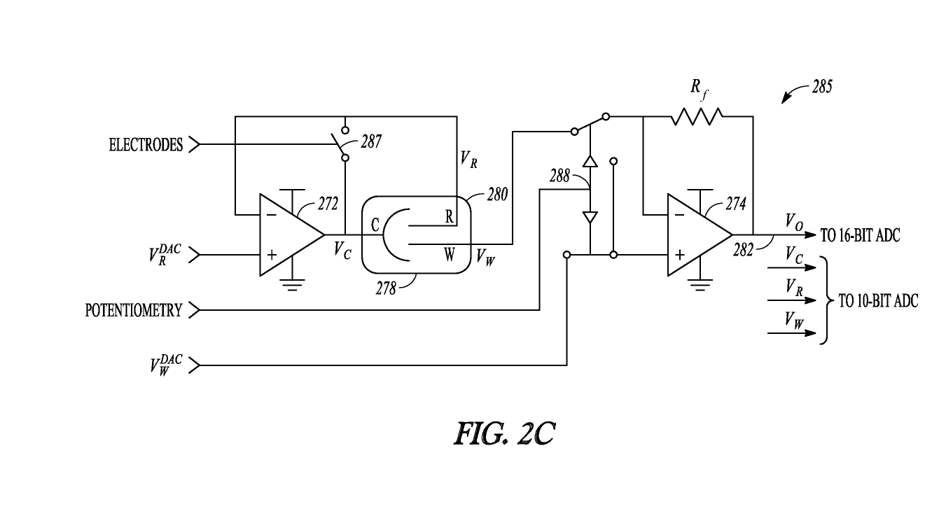

FIG. 2A is a block diagram that describes one example hardware and interconnection design of a telemedicine device 200. The device in one embodiment may be mounted on a custom printed circuit board (Advanced Circuits for example) measuring 2″×4″, and features: (1) a custom three-electrode potentiostat 205 for electrochemical measurements, (2) a socket 210 for interfacing with test strips 215, (3) an LCD screen 220 (Nokia 5110, SparkFun Electronics for example) and three buttons 225 for interfacing with the user, (4) an audio port 230 for telecommunication of data, (5) a battery 235 to power the device, (6) a microcontroller 240 to operate the device, (7) a serial port for programming the microcontroller 240, and (8) a custom 3D-printed ABS case 245 (Fortus 250mc, Stratasys for example). In one embodiment, a small vibration motor may be added to mix samples when required.

At the heart of the device is a microcontroller, such as an Atmega328 (Atmel) 8-bit microcontroller for example featuring a 6-channel, 10-bit analog to digital converter 250 (ADC), 14 channels of digital input/output (110) lines 255, and 6 channels of pulse width modulation (PWM) lines 260. The microcontroller 240 sets the potentiostat 205, measures the required signals (as voltages), computes and encodes the data, transmits and receives frequency-modulated signals, and operates the LCD screen 220.

The microcontroller 240 may be compatible with a popular Arduino development environment, which provides an easily accessible application development cycle. Other microcontrollers may be used in further embodiments. Also included at low pass filters 262 and audio filters 264.

FIGS. 2B and 2C are alternative circuit designs 270 and 285 for the switchable three- and two-electrode potentiostat. A potentiostat is a device that is used to control and measure the rate of a reaction in an electrochemical cell. This hardware consists of a pair of electrodes (working and reference) to establish a stable potential difference ΔV=V!−V! between two points in the sample, and a third electrode (counter) to supply a current I that maintains the applied potential difference ΔV. This current typically correlates to the concentration of the active electrochemical analyte.

In FIG. 2B, a three-electrode potentiostat 270 utilizes a basic dual op-amp configuration 272, 274 that minimizes the number of electrical components, resulting in low cost and low power consumption. A field effect transistor (FET) switch 276 electrically shorts a counter (C) 278 and reference electrodes 280 together when its gate electrode is driven high. Conversely, it disconnects the two electrodes when its gate is grounded. This behavior enables the programmable switching of the potentiostat between a three- and two-electrode configurations.

To set the voltages of the reference (R) and working (W) electrodes, V_{R} and V_{W}, the microcontroller outputs 282 a pair of 10-bit pulse width modulation (PWM) signals. These signals pass through a pair of low-pass filters 262 to remove all oscillating harmonics, and the resulting voltages are fed directly to the potentiostat. This allows a 3.2 mV resolution of the voltage setpoints within the voltage range of 0-3.3V with up to a 6 ms rise time. The resolution of voltage setpoints and range may vary with different microcontrollers. The rise time may also be varied, and may be significantly faster such as by modification of filtering electronics.

The applied voltage ΔV=VR−VW in one embodiment has a practical range of ΔV=−2V to 2 V to make sure that the voltage generated by the signal does not go out of range of the ADC. Voltage ranges may be expanded by using higher voltage batteries or batteries in series in further embodiments. A feedback resistor R_{f} converts the current I generated by the sample into an output voltage V₁=V_{W}−IR_{f}. The ADC samples V₁, V_{W}, and V_{R}. These values, together with an independent measurement of R₁, allow the microcontroller to compute the instantaneous value of ΔV and I.

Setting the gate electrode of the FET to high (3.3V for example) configures the potentiostat for two-electrode operation. Chronoamperometry is a simple technique for measuring the concentration of species that can be oxidized or reduced at the working electrode through the application of a fixed potential for a fixed duration. The measured current from the redox process correlates to the concentration of the redox species. This measurement technique is often used to quantify metabolites through coupling with an enzymatic reaction that produces an active redox species. For example, glucose oxidase (an enzyme) converts glucose (the analyte) and potassium ferricyanide (an electrochemical mediator) to gluconic acid and potassium ferrocyanide, which can be measured by chronoamperometry.

Alternative potentiostat 285 in FIG. 2C is a custom-made, three-electrode potentiostat to perform electrochemical measurements, three digital switches 287, 288 to reconfigure the potentiostat. Potentiostate 285 in one embodiment consists of two operational amplifiers (AD8608, Analog Devices) 272, 274. The set the reference voltages with a 16-bit DAC (PN) and measured the output current with a 16-bit ADC (PN). The set of digital switches 287, 288 enable the microcontroller to reconfigure the potentiostat between two- and three- electrode operation and between amperometric or potentiometric measurement.

The versatility of the reconfigurable potentiostat may be observed by programming the device to perform five important types of electrochemical measurements: (i) cyclic voltammetry (CV), (ii) chronoamperometry, (iii) square wave voltammetry (SWV), (iv) differential pulse voltammetry (DPV), and (v) potentiometry.

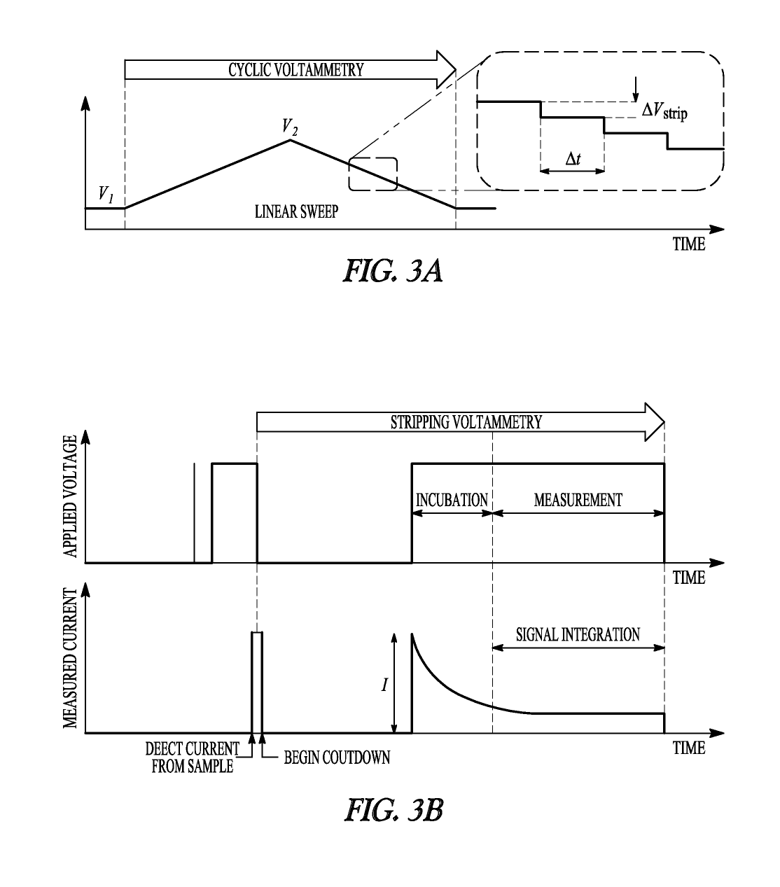

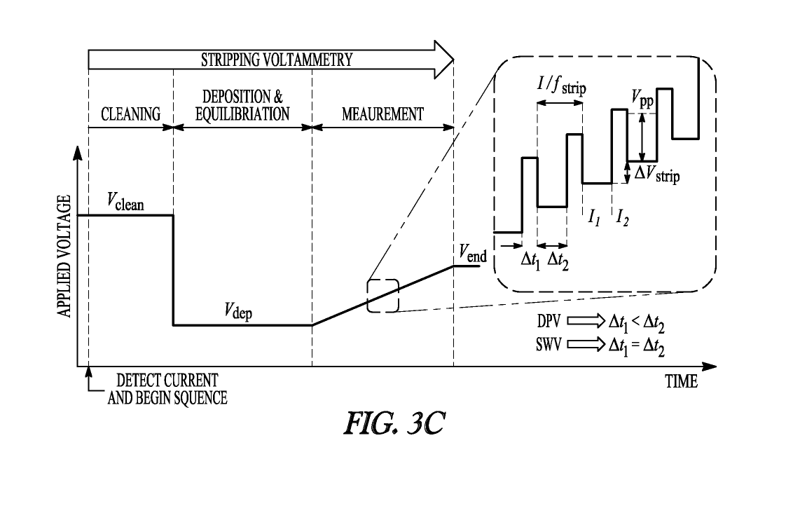

FIGS. 3A, 3B, and 3C show time and voltage sequences for the different types of measurements, and, when appropriate, the expected transient behavior of the measured current. To compare the performance of the device to that of a sophisticated electrochemical analyzer (AUTOLAB), we used both devices to perform a series of test measurements for each type of pulse sequence that we implemented. The figures show timed sequence of applied voltages and measurement for (FIG. 3A) cyclic voltammetry, (FIG. 3B) chronoamperometry, and (FIG. 3C) stripping voltammetry by differential pulse voltammetry and squarewave voltammetry.

In one embodiment, the microcontroller begins by applying a potential to test for the presence of the sample solution. With the test strip inserted, but no sample present, there are no mobile ions to carry charge (current) between the electrodes, and the circuit is open. As soon as a sample enters the test strip, the presence of hydrated ions imparts some conductivity to the test zone, resulting in a measurable current.

Cyclic voltammetry (FIG. 3A) measures the current in a three-electrode electrochemical cell while the potential ΔV is swept linearly from V₁ to V₂ (and back again). Since a DAC, generally, cannot generate a smooth ramp in voltage, the linear sweep is approximated by a staircase potential with steps ΔVₛₜₑₚ each held for a duration Δt. The ramp-rate is thus characterized by ΔVₛₜₑₚ/Δt. For measurements using CV, the microcontroller may be programmed to configure the potentiostat for a three-electrode measurement of current. A cell may be used having three electrodes consisting of a carbon working electrode, a platinum counter electrode, and an Ag/AgCl reference electrode.

Chronoamperometry (FIG. 3B) is a simple technique for measuring the concentration of a species that can be oxidized or reduced at the working electrode through the application of a fixed potential ΔV for a fixed duration. The measured current I from the redox process in a two-electrode electrochemical cell correlates to the concentration of the redox species. This measurement technique is often used to quantify metabolites through coupling with an enzymatic reaction that produces an active redox species. Typically, the current measured following application of the potential, includes a large capacitive component that is not related to the concentration of the analyte. In one embodiment, the measurement begins at the point where the Faradaic current is dominant, During this time the measured current I is linearly proportional to the concentration of analyte in the sample and ideally displays a transient decay obeying the Cotrell-Equation such that I t=c₀At^{-1/2}, where A is a constant that depends on the electrical, geometric, and diffusion properties of the mediator, test strip, and analyte. The current may be averaged over a fixed length of time Δt to reduce the contribution of white noise by a factor of 1/(Δt)^{1/2}. For all measurements involving chronoamperometry, the potentiostat may be configured for a two-electrode measurement of current.

Differential-Pulse Voltammetry and Square-Wave Voltammetry (FIG. 3C) measures the current in a three-electrode cell generated a series of regular voltage pulses with height ΔV_{PP} and f=(Δt₁+Δt₂)⁻¹(where Δt₁ is the pulse duration and Δt₂ is the time between pulses) are superimposed on a linear sweep from V_{dep} to V_{end}. The currents I₁ and I₂ are recorded immediately before a change in voltage (i.e. at end of the pulse). The value of the maximum difference in current ΔI=I₁−I₂, is linearly proportional to the concentration of analyte. This approach reduces the contribution of the large capacitive current generated after each change in potential and enables higher sensitivity to low concentrations. In DPV, Δt₁<Δt₂ and in SWV Δt₁=Δt₂. For these measurements, the potentiostat may be configured for three-electrode measurement of current. A three-electrodes cell may be used consisting of carbon working electrode, platinum counter electrode, and Ag/AgCl reference electrode.

Potentiometry is used to measure the voltage generated within a two-electrode electrochemical cell. To maintain a constant ΔV, the detection circuit must have extremely high impedance to minimize the current consumed during measurement (to prevent destabilization of the generated potential). Operational amplifiers are selected for the potentiostat circuit that provide an input impedance of ˜10¹² Ω, which is comparable to commercial electrochemical potentiometers and pH meters and is sufficient for measurements performed on physiologically relevant ranges of concentrations.

The device may also be used for the detection of (i) glucose in serum by chronoamperometry with commercial test-strips, (ii) heavy metals in water by square wave voltammetry using commercially available screen-printed electrodes, and (iii) electrolytes in urine by potentiometry using ion-selective electrodes. Commercial test strips and electrodes may be used for all measurements to reliably evaluate the performance of the device, ensure proper calibration, and determine the limits of detection in all modes of measurement. These components are readily available and ensure that the device is immediately applicable to real-world situations.

For the POC detection of glucose by chronoamperometry, commercial test strips (TrueTrak, CVS) may be used that have a pair of electrodes—working and counter—defined by carbon ink and all the necessary reagents (e.g., enzymes and electrochemical mediator) pre-stored on the test strip.

The device may be programmed to first apply a fixed potential (FIG. 3B) to test for the presence of the sample in the reaction zone. With the test strip inserted, but no sample present, there are no mobile ions to carry charge (current) between the electrodes, and the circuit may be open. When a sample is placed on the test strip, the presence of hydrated ions imparted some conductivity to the test zone that can be measured as current. A spike in the current may trigger the chronoamperometry sequence, which begins with an incubation period at zero applied voltage and followed with a measurement period at a constant applied voltage.

To detect heavy metals, a Square-Wave Anodic Stripping Voltammetry (SWASV) may be used. This procedure utilizes a four-step pulse sequence (FIG. 3C): (i) Cleaning: A positive potential (V_{clean}) applied to the working electrode oxidizes any impurities from the electrode surface in order to prepare it for the measurement; (ii) Deposition: A negative potential (V_{dep}) applied to the working electrode causes metal ions in solution to reduce onto the electrode surface, if the potential is below the reduction potential of the metal. The solution must be agitated during this step so that the rate of deposition is not diffusion limited; (iii) Equilibration: The potential is maintained at V_{dep} with no agitation for a short time to ensure solution equilibrium (iii) Measurement:

SWASV causes the metals deposited on the electrode surface to re-oxidize and re-dissolve into the solution. The reoxidation occurs when the potential at the working electrode matches the oxidation potential of the metal, so that the measured current exhibits a different peak for each metal species.

In SWASV, agitation facilitates the deposition of the ions onto the electrode. To eliminate the need for magnetic stirring in an electrochemical cell (a configuration that would add cost and complexity) a small vibration motor may be incorporated into the device to vibrate a screen-printed electrode and enhance the depositions of ions onto the working electrode. This approach enabled use of a small sample volume combined with the appropriate reagents on the top of the electrode. The device may be programmed to activate the vibration to provide agitation during the cleaning and depositions steps.

Heavy metals (Zn(II), Cd(II) and Pb(II)) may be measured in water samples using commercial test strips (DRP110-CNT, DropSens) with three screen-printed electrodes: (i) a working electrode consisting of carbon ink modified by carbon nanotubes, (ii) a counter electrode consisting of carbon ink, and (iii) a reference electrode consisting of Ag/AgCl ink. To measure the concentration of metal ions, a 100-μL droplet of both the reagent and the sample may be added on top of the screen-printed electrode and the device performs the sequence, measures the current, and handles the data.

Finally, potentiometry may be used to detect the concentration of K, Na, and Ca ions in a urine sample with ion selective electrodes. The electrodes may be dipped into the urine sample and the potential difference between the reference electrode and the working electrode, the implemented time and voltage sequence for chronoamperometry, and the expected transient behavior of the measured current in one example embodiment may be measured.

In one embodiment, a nonzero measured current triggers a chronoamperometry sequence, which begins with an incubation period at zero applied voltage, followed by a measurement period at a constant applied voltage. During this time the measured current I ideally displays a transient decay obeying the Cotrell-Equation such that I(t)=C₀At^{-1/2} where A is a constant that depends on the electrical, geometric, and diffusion properties of the mediator, test strip, and analyte.

The integrated current can be calibrated as a function of the concentration of glucose in the sample. Compared to sampling at only one specific time, integration helps to reduce the contribution of white noise by a factor of 1/ΔT^{-1/2}.

In one embodiment, the device contains enough memory (32 kilobytes) to store approximately ten different pulse sequences and approximately 500 16-bit data points for on-board analysis in addition to the remaining code that operates all other functions of the device. Basic statistical analysis and baseline corrections may be performed to extract the concentration of an analyte from the raw data directly on the device. The user simply selects the appropriate measurement from a programmed menu and, after the measurement is completed, the measured concentration of the appropriate analyte may be displayed on the screen (and uploaded to a remote facility if desired.

A mobile voice-channel is especially noisy and prone to signal interruption (burst noise) rendering analog modulation inappropriate for transmission of numeric data, such as concentrations of analytes, or patient identification numbers. It is, therefore, simpler to transmit these data by digital modulation that can be supplemented with error detection or correction. A frequency shift keying (FSK) protocol is used to transmit digital data over the audio channel of a mobile phone during a live connection.

A new data transmission protocol is used to communicate over the audio channel of a mobile phone. This approach guarantees universal operation with any phone that has an audio port, even a low-end mobile phone. The mobile voice frequency range is typically 500-3300 Hz and the microphone port of a mobile phone is designed to accept audio signals range of 0-5 Vpp. Since the ATmega328 microcontroller can only output digital signals, data is represented as a sequence of square wave tones and pass the output signal through a passive low-pass filter that attenuates all but the lowest-order sinusoidal harmonic.

A simple packet structure used has two sections: (i) a header that identifies the quantity measured and (ii) a body containing the measured data encoded with an error detecting code. The header may be a tone with a unique frequency different from the frequency of the tones used to represent digits. Each type of sensed data may have one or more unique tones to clearly identify the type of data at the beginning of the packet.

In one embodiment, the voice bandwidth may be divided into a band for the data (f=500 Hz to 1400 Hz) and a band for the header (f>1500 Hz). The data band may be further subdivided into for example ten 100 Hz intervals that are bijectively mapped onto the integers (0-9). The header may be composed of a 50-ms tone that identifies whether the data being transmitted corresponds to glucose (1600 Hz) or lead (1700 Hz). The body contains an integer valued, base-10 representation of the concentration of a single analyte. Each integer in the sequence is represented by a single 50 ms tone at a frequency corresponding to the integer value. For example, a packet of data transmitting the integer 31415 would contain a body that is 250 ms long (5×50 ms) and a frequency sequence of (700, 500, 800,500, 900) Hz. This is just one example of encoding data. Many other may be used in further embodiments using different length tones at different frequencies to represent integers in different bases, such as for example base 2, 3, 4, 5, 6, 7, 8, 9, 11, 12 and higher.

Since the voice channel of a mobile network is particularly vulnerable to burst noise, lost packets, and low signal strength, we included an error detection scheme into the packet encoding and decoding algorithm. A commonly used n-bit cyclic-redundancy check (CRC) may be used that allows the validation of uncorrupted data. The CRC performs polynomial long division between the data and a suitably chosen polynomial and appends the remainder to the data before transmission. When the remote application (e.g. Matlab via Skype on a personal computer) receives the data, it divides the recovered numeric sequence by the same polynomial value. A null remainder corresponds uniquely to an uncorrupted data packet.

In one embodiment, a 10-bit CRC (Ob1000000001) may be used that guarantees detection of all errors for sent values up to 2¹⁰=1024. For larger values, a longer CRC may be used for reliable detection of errors. Different error checking and even error correcting codes may be used in further embodiments.

Upon finishing data acquisition, the device is programmed to automatically begin sending the computed value and checking for a data receipt acknowledgement. A standard 3 5 mm TRRS stereo connector and corresponding stereo cable may be used to couple the signal output of the device to the microphone port of a mobile communications device, such as a Nokia model 1112 mobile phone.

In further embodiments, the device may include a speaker to play the audio tones in a manner that a communications device may receive and transmit the audio tones without the use of a hard wired connector to the phone. This capability would allow the device to operate with any type of communications device, such as a mobile phone, computer coupled to a communications network, a land line telephone or other device. Given that audible noise may be more prevalent when communicating tones in this manner, a more robust error checking code may be used to ensure proper reception of the tones.

The user then places a standard call from the mobile phone to a VoIP application such as Skype or other voice over IP application, or any other type of communication protocol allowing sending and receiving of audio tones, on a remote personal computer to establish a live voice link. The mobile phone thus serves to route the FSK signal data from the telemedicine device directly to the number called. The receiving computer samples the audio data from the packet stream with a program written in Matlab in one embodiment. In further embodiments, other software-based modems may be used on both sending and receiving sides. In still further embodiments, hardware modems may be used on one or both sides. Other commercially available modems may be used in further embodiments to communicate using frequency shift keying at low baud rates.

The data acquisition program isolates and divides each received message into 16 segments (the number of bits in the message) and performs a rolling Fast Fourier Transform (FFT) to obtain the frequency spectrum of each segment. A hardware modem can be used to obtain higher speeds. Ten 50 Hz-wide digital band-pass filters, centered at the transmission frequencies, may be used to determine the dominant frequency of each segment of the packet. The recovered sequence of frequencies is then decoded back into the transmitted sequence of integers.

In one embodiment a Matlab program is used to check each received packet for errors with the CRC method and, upon receipt of an uncorrupted data packet, plays a constant 500 Hz tone back to the phone (through Skype) as an acknowledgement. The telemedicine device intermittently listens for the acknowledgement tone on its left audio channel in one embodiment. Upon receipt of the acknowledgment, the microcontroller ceases the transmission of data packets and displays a message to inform the user that the data has been sent.

Finally, the Matlab program sends the decoded value or a diagnostic interpretation as an SMS through a web-portal of a chosen mobile carrier.

In one example embodiment, self-testing of blood glucose using a glucometer is one of the most commonly performed point-of-care measurement around the world. A typical hand-held glucometer uses a two-electrode (counter and working) potentiostat to apply a simple voltage sequence that consists of an incubation period at zero applied voltage followed by a measurement period at a fixed applied voltage (typically +0.5 V). The current measured in the latter half of the detection sequence is proportional to the concentration of glucose in the sample.

In one embodiment, a two-electrode chronoamperometry mode of the telemedicine device may be used with an extended version of the timing sequence performed by a popular hand-held glucometer such as a TrueTrak, CVS, featuring a five second incubation time and a ten second measurement time at Δ=+0.5V performed at a sample rate of 8 Hz. Sample rates and measurement time may vary significantly in further embodiments.

In one example, a dilution series of D-glucose (Sigma Aldrich) in a PBS buffer may be used to test each solution by applying a single droplet to a commercial glucose test strip (TrueTrak, CVS). The current measured in the initial period, following application of the potential, includes a large capacitive component that is not related to the concentration of the analyte. Therefore the integration is begun five seconds after the application of the potential, so that the oxidation of ferrocyanide, which follows the Cottrell equation, is the dominant source of current.

FIG. 4 is a flow chart describing the sequence of operations 400 involved establishing error-free communication over a mobile voice network 405 between the device at 410 and a remote computer at 415. At the remote computer 415, an audio stream is received via VoIP and recorded at 420, (ii)

analyze and identify frequency content of each packet at 425 via a rolling FFT, (iii) convert the sequence of tones into a corresponding sequence of integers at 430, (iv) identify the type of measurement, (v) verify the integrity of

the received data with a CRC at 435, and if error-free at 440 as signified by a null remainder, (vi) log and display the data to the remote user at 445, (vi) play an acknowledgement (ACK) tone (5 s, 500 Hz) to the VoIP application, and (vii) send the decoded value or a diagnostic interpretation to the local user's mobile phone in the form of a text message over short messaging service (SMS) at 450, sent through the web-portal of the chosen mobile carrier (AT&T). In one embodiment, the device 410 may send packets continuously until it receives an ACK at 455 from the remote computer and, upon receipt, to cease the transmission of data packets and display a message informing the user.

Device 410 receives raw data at 460, applies a CRC at 465, encodes the digits into tones at 470, plays the tone sequence to the audio port at 480, and listens for an acknowledgement at 482. If not received at 484, the tones are continuously played at 480 until received. If received at 484, the receipt is acknowledged to the user at 486. The sequence begins when the device is coupled to the mobile phone 488, and a call the network is placed at 490. The mobile phone provides the tones to the network as indicated at 495 and also receives data back from the network as indicated at 498.

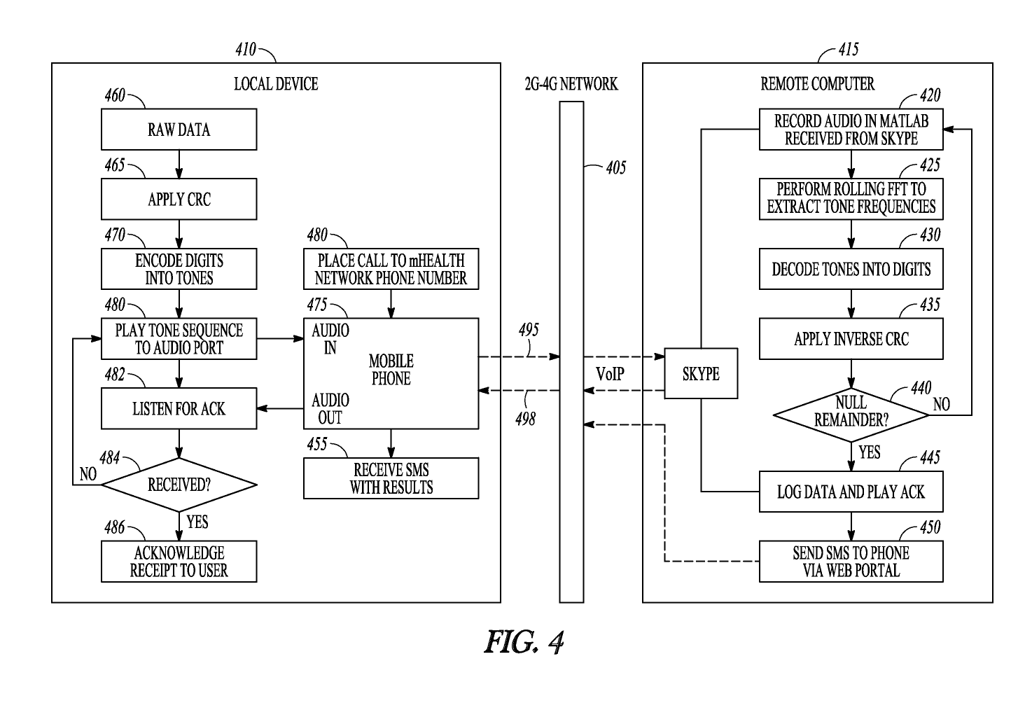

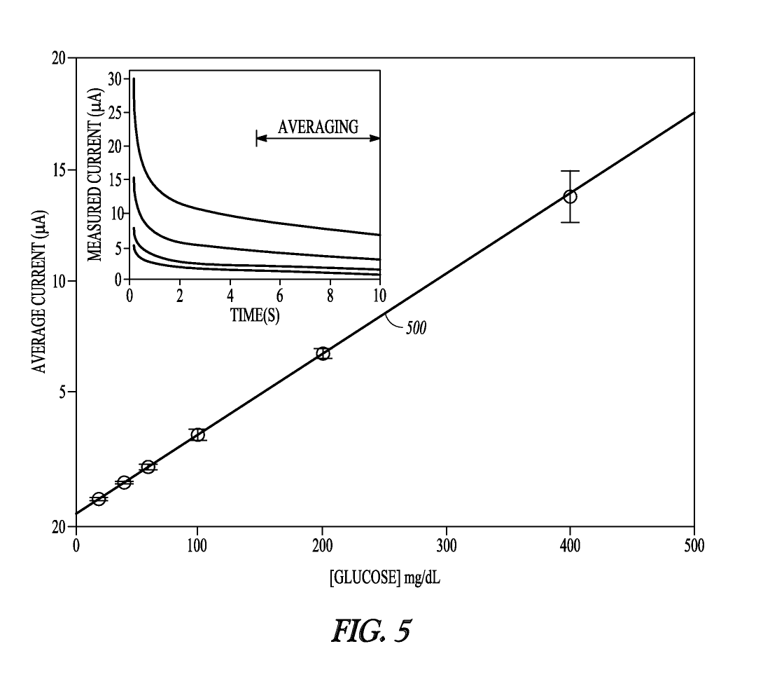

FIG. 5 shows the average current 500 as a function of the concentration of glucose in the sample applied to the disposable test strip (TrueTrak, CVS). The current is averaged over the last five seconds of the measurement.

Tuning the feedback resistor in the current to voltage converter can easily increase the dynamic range of the device at the expense of sensitivity.

A three-electrode ASV measurement sequence may be used for detection of lead following the timing previously described and shown in FIG. 3B. A feedback resistance of R_{f}=48.5 kΩ and suitable DC offsets for all electrodes may be used in order to place all of the desired measurements in the range of the potentiostat.

In one example, a series of solutions of lead (0 to 450 ppb) in a buffered solution of acetate (100 mM, pH 4.6) containing 500 ppb bismuth as a co-deposition agent may be used to test the device. Next each solution may be tested by placing a single drop on the reaction zone of a commercial electrochemical test strip (Zensor), which may be modified to fit the test strip port of the device.

To calculate the concentration of analyte, the difference between the maximum current in the potential window corresponding to the oxidation of lead (ΔV=−0.9V to −0.75V) and the background current at ΔV=−0.9 V.

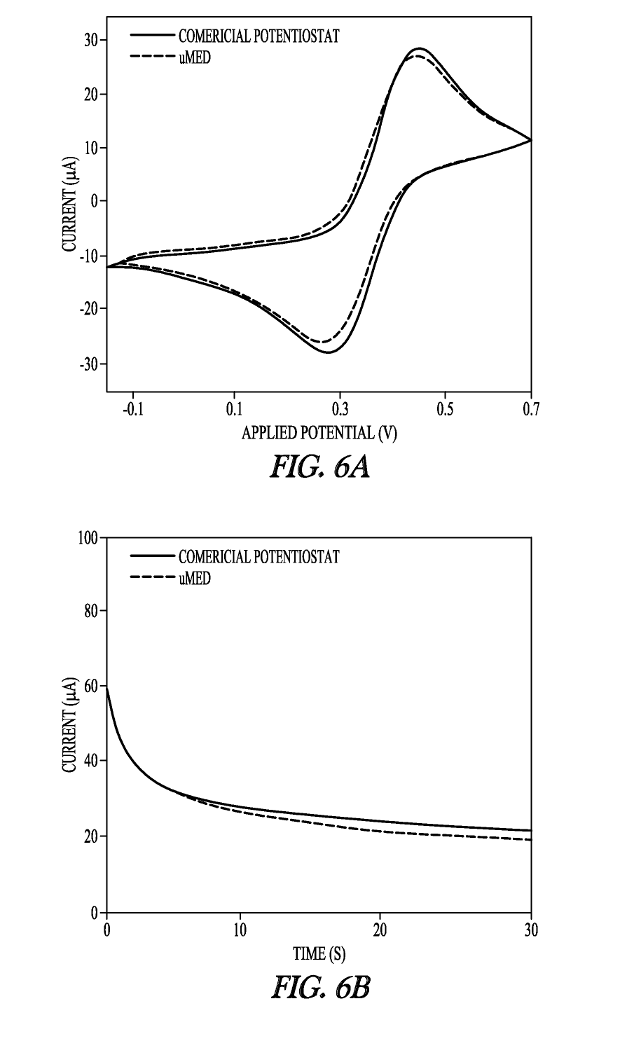

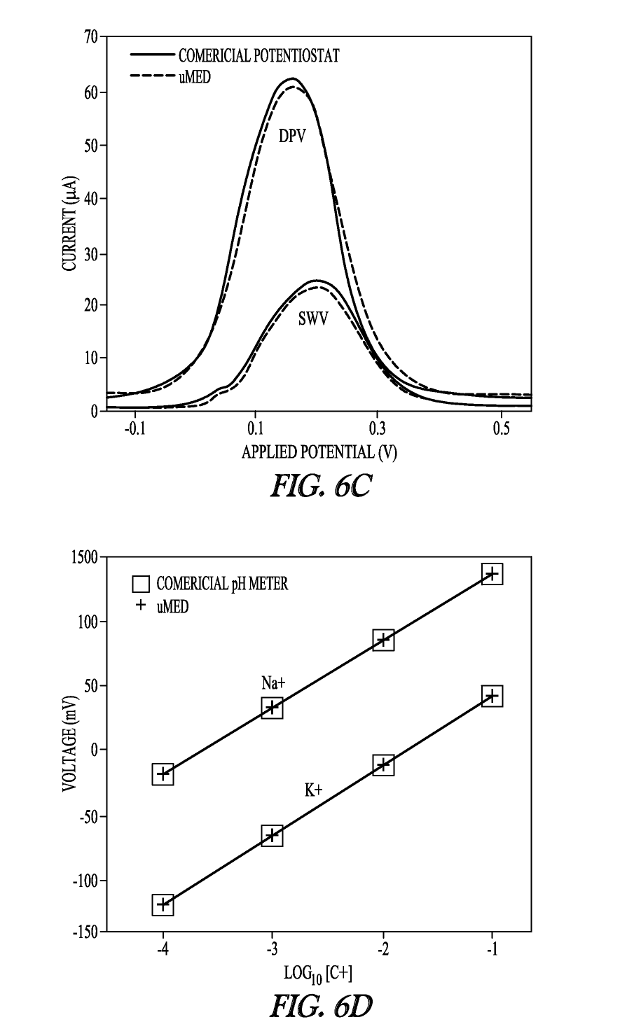

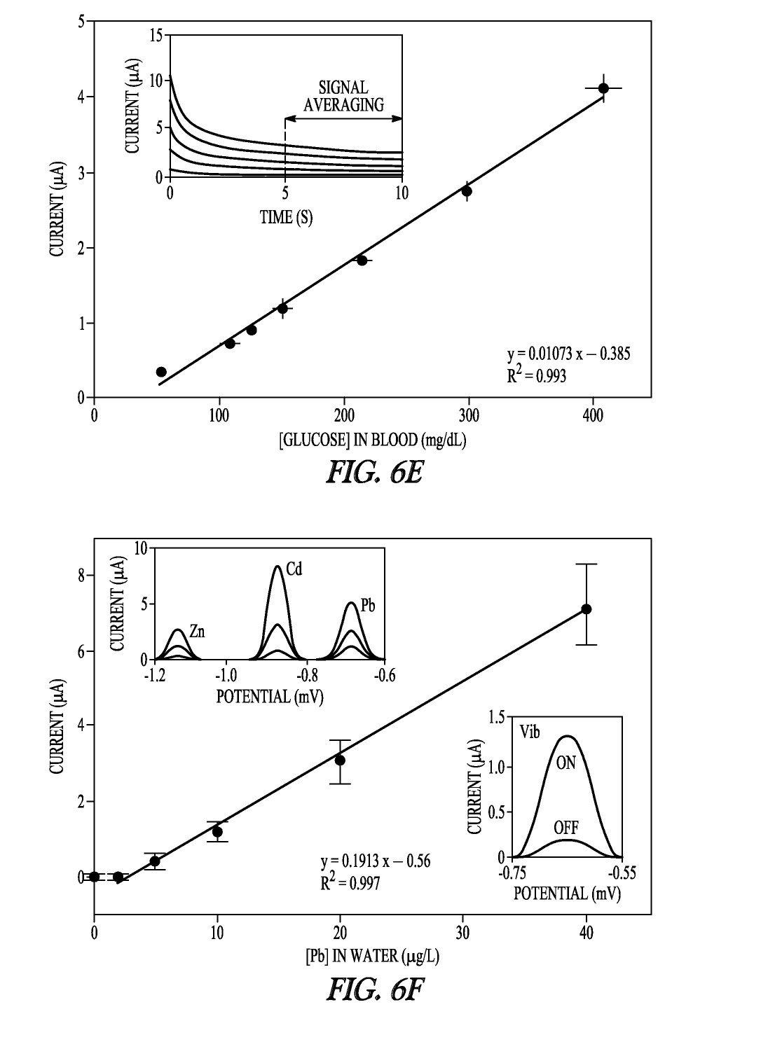

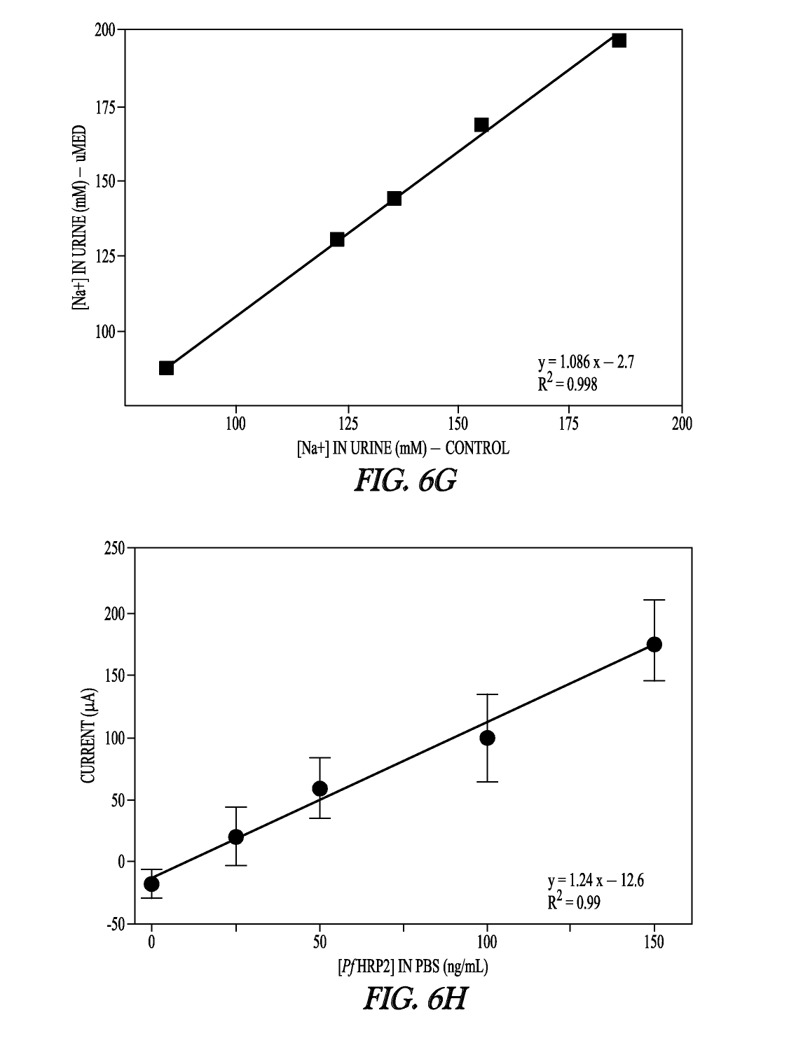

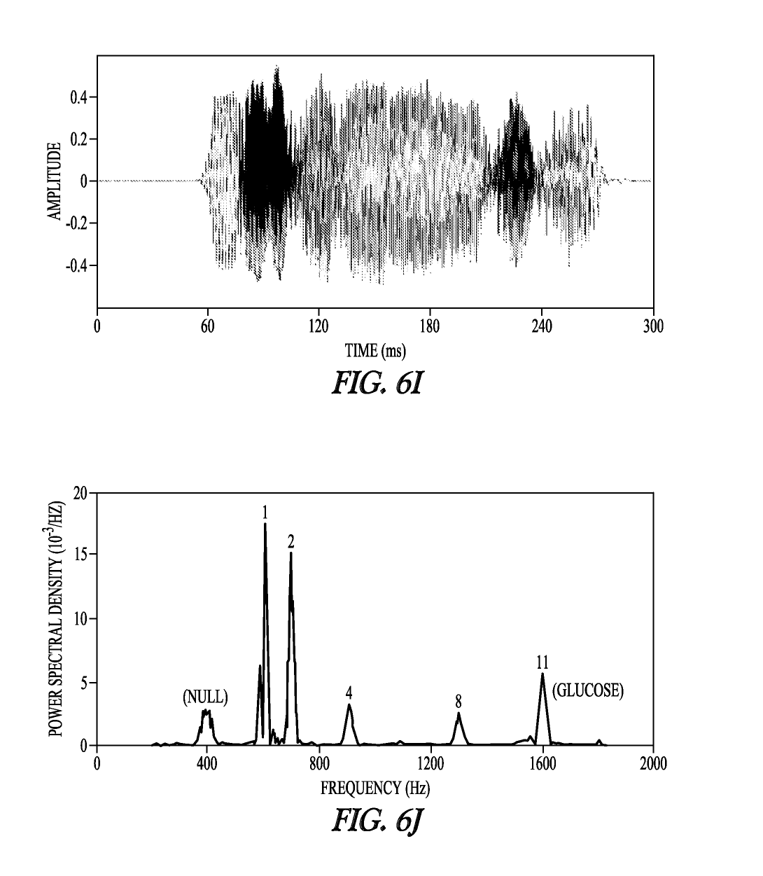

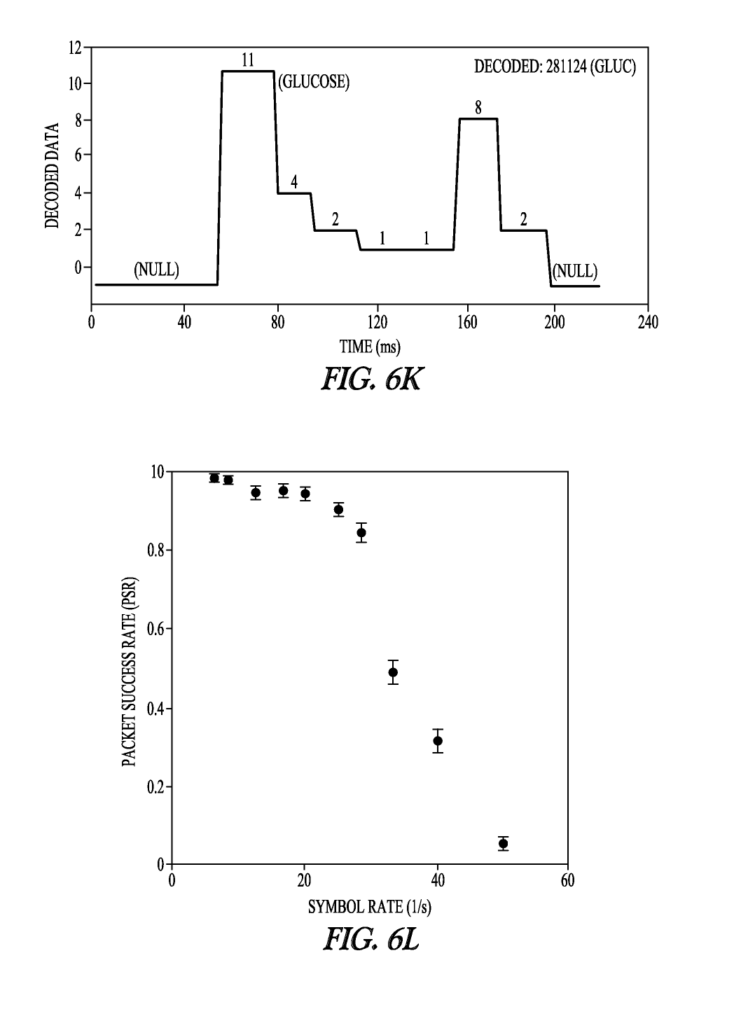

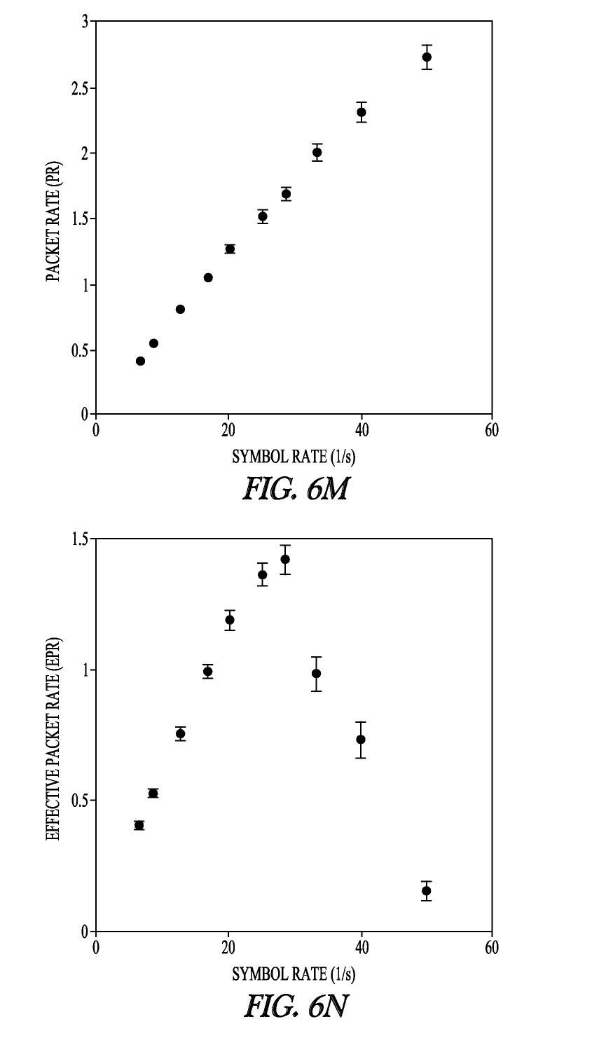

FIG. 6A is a graph illustrating a cyclic voltammagram according to an example embodiment. In particular, the graph represents a cyclic voltammagram of 2.5-mM ferricyanide/ferrocyanide in 0.1-M KCl.

FIG. 6B is a graph illustrating measured current versus time for an example chronoaperometry according to an example embodiment. In particular, the graph represents a plot of the measured current versus time for chronoamperometry performed on 1-mM ferrocyanide in 0.1-M KCl.

FIG. 6C is a graph illustrating differential-pulse and square-wave voltammagrams according to an example embodiment. The graph represents differential-pulse and square-wave voltammagrams of 1-mM 1-naphthol in 100-mM tris, 100-mM NaCl.

FIG. 6D is a graph illustrating detection of K⁺ and Na⁺ with potentiometry in an ionic strength adjuster according to an example embodiment. The graph represents detection of [K+] and [Na+] with potentiometry in an ionic strength adjuster.

FIG. 6E is a calibration plot of current versus concentration of glucose in assayed samples of human blood measured by chronoamperometry according to an example embodiment. In further detail, the calibration plot represents current versus concentration of glucose in assayed samples of human blood measured by chronoamperometry. The insert is a plot of the transient current for five representative concentrations of glucose (107, 150, 215, 298, and 408 mg/dL).

FIG. 6F is a calibration plot of peak current versus concentration of lead according to an example embodiment. The calibration plot in detail represents the peak current versus the concentration of lead measured by SWASV. An upper inset shows simultaneous detection of three heavy metals (Zn, Cd, and Pb) at three concentrations (5, 10, and 20 μg/L). A lower inset illustrates a comparison of the peak height for a 10-μg/L solution of lead with and without the use of vibration during deposition.

FIG. 6G is a graph illustrating detection of Na⁺ in assayed human urine control samples measured by potentiometry according to an example embodiment.

FIG. 6H is a calibration plot of current versus the concentration of PfHRP2 in PBS(1×) according to an example embodiment. In all cases, the error bars indicate the standard deviation of n=7 independent measurements.

FIGS. 6I-6N illustrate an example of a successfully transmitted packet and an analysis of the average throughput of data versus symbol rate. A randomly chosen value 274 mg/dL of glucose is encoded as 2-8-1-1-2-4-11 after CRC. The “11” corresponds to glucose. The data was transmitted over an active voice connection.

FIG. 6I is a plot of a received audio signal according to an example embodiment.

FIG. 6J is a graph illustrating an FFT of a packet demonstrating the presence of seven distinct frequency signals and the values to which they correspond according to an example embodiment.

FIG. 6K is a graph illustrating a decoded packet containing a sequence according to an example embodiment. The decoded packet containing the sequence (read in reverse) 2-8-1-1-2-4-11, which, after removing the CRC value, decodes to the value 274-11, or 274 mg/dL of glucose.

FIG. 6L is a plot illustrating an overall PSR versus symbol rate according to an example embodiment.

FIG. 6M is a plot illustrating PR versus symbol rate according to an example embodiment.

FIG. 6N is a plot illustrating the EPR versus the symbol rate (EPR=PSR·PR) according to an example embodiment. The optimal EPR=1.4 packets/s occurred at 29 symbols/s. The error bars in FIG. 6L signify the standard error of the mean

$${Σ}_{PSR} = \sqrt{\frac{PSR ( 1 - PSR )}{N}} ,$$

where p is the packet success rate, and N=300. The error bars in FIG. 6J are propagated from FIG. 6I by

$${Σ}_{EPR} = \sqrt{{( \frac{\partial EPR}{\partial PSR} {ɛ}_{PSR} )}^{2} + {( \frac{\partial EPR}{\partial PR} {ɛ}_{PR} )}^{2}} ,$$

where ε_{PR} is the measured standard deviation in PR.

Full system operation may be demonstrated by measuring the concentration of glucose in a sample of blood from a single user, and the concentration of lead in tap water, and reporting each result separately, through a low-end mobile phone such as a Nokia 1112, to a remote laptop computer running a custom Matlab interface.

In practice, a packet error rate can be about 2-15%, depending on the chosen baud-rate and amount of noise present on the voice channel. An implemented CRC error detection works well, providing the ability to discriminate between uncorrupted and corrupted packets at a 100% success rate thus far. The time it takes to receive the acknowledgement message “SENT” (indicating that the message was sent and received by the PC) is approximately two seconds, although this can be longer depending on mobile carriers or signal strength. More rigorous testing may be performed.

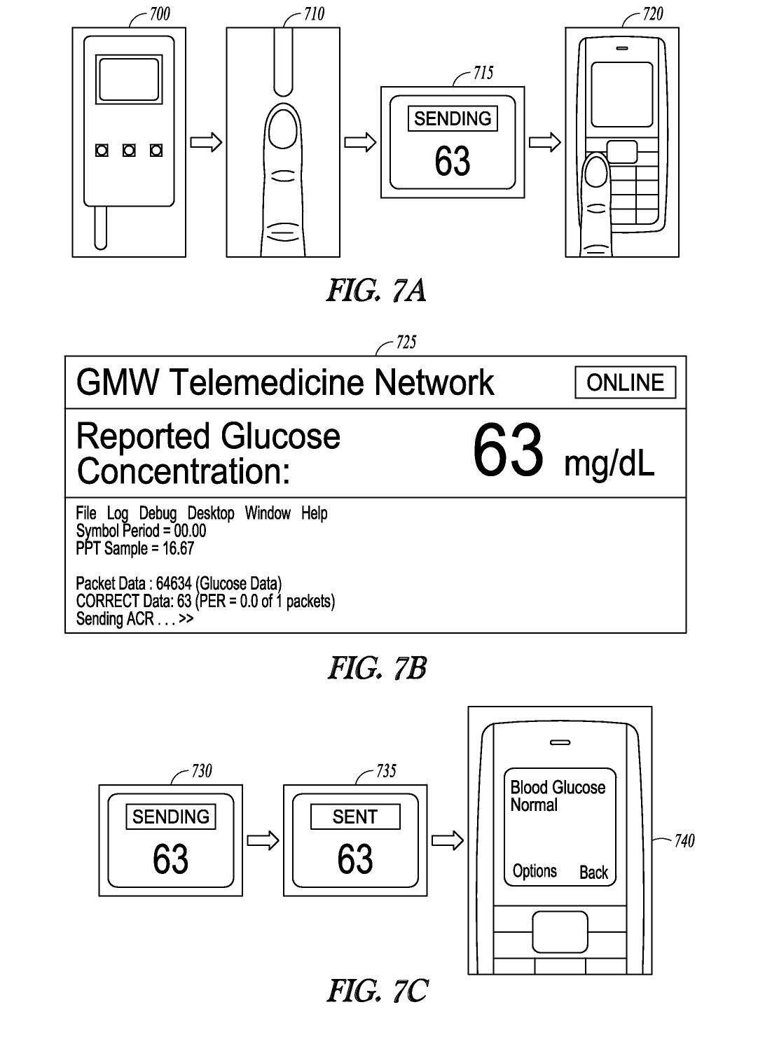

FIGS. 7A, 7B, and 7C illustrate a demonstration of the telemedicine network in operation. In FIG. 7A at 700 a local user makes a blood glucose measurement with the telemedicine device via a finger prick to produce a drop of blood at 710. When the measurement is finished as indicated at 715 with a glucose value of “63” displayed, the device automatically begins to send the data. The user then places a call as indicated at 720 from the mobile phone connected to the device.

In FIG. 7B, the remote user receives the data at 725 through a Matlab application, which sends an acknowledgement tone upon receipt of an uncorrupted packet and an SMS message to the local user. In FIG. 7C the message is shown as sending at 730 and having been sent at 735. The local user receives the acknowledgement and SMS message displayed at 740 on the telemedicine device and mobile phone respectively.

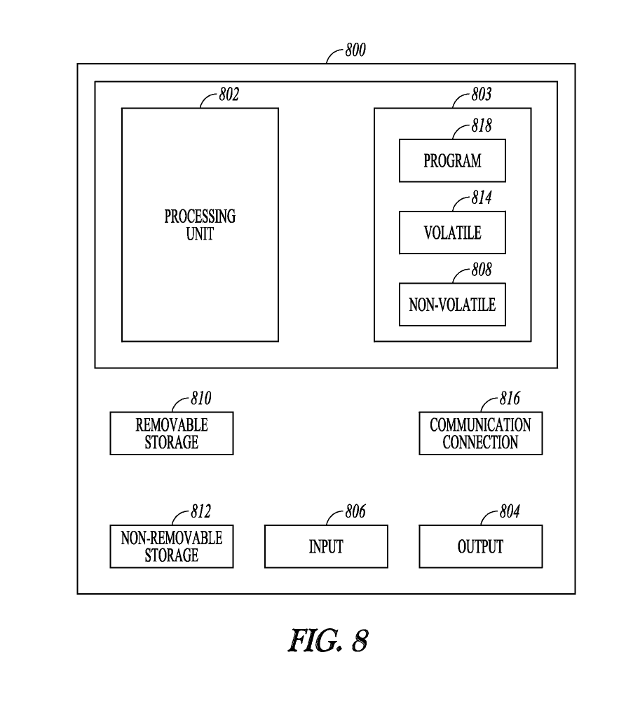

FIG. 8 is a block schematic diagram of a computer system 800 to implement various components and methods according to an example embodiment. Note that not all components need be used for various implementations. One example computing device in the form of a computer 800, may include a processing unit 802, memory 803, removable storage 810, and non-removable storage 812. Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 800 may include or have access to a computing environment that includes input 806, output 804, and a communication connection 816. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 802 of the computer 800. A hard drive, CD-ROM, and RAM are some examples of articles including a non-transitory computer-readable medium. For example, a computer program 818 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 800 to provide generic access controls in a COM based computer network system having multiple users and servers.

### EXAMPLES

1. A device comprising:
a sensor to detect a parameter related to a diagnostic test;
a controller coupled to the sensor to receive sensed information from the sensor and generate binary data representative of the parameter; and
a tone generator to encode the binary data and provide audio tones to couple to a communication device.

2. The device of example 1 wherein the audio tones are provided as electrical audio signals compatible with a microphone input of the wireless communication device comprising a cellular telephone.

3. The device of any of examples 1-2 wherein the sensor provides sensed information corresponding to an electrochemical test.

4. The device of any of examples 1-3 wherein the sensor comprises a glucose meter.

5. The device of any of examples 1-4 wherein the sensor comprises an optical sensor.

6. The device of any of examples 1-5 wherein the binary data comprises integer data, and wherein the tone generator generates a separate tone for each integer.

7. The device of example 6 wherein the tone generator provides a header audio tone representative of the type of sensed data prior to sending a set of separate tones corresponding to each integer.

8. The device of example 7 wherein the audio tones are repetitively sent with a delay between each repeated header and set of tones.

9. The device of example 8 wherein the set of tones includes an error checking code.

10. The device of example 9 wherein the controller is coupled to receive an acknowledgement code indicating that the set of tones was properly received, and to cease the sending of the set of tones.

11. The device of example 9 wherein the error checking code comprises cyclical redundancy check code.

12. A method comprising:
receiving data representative of a parameter corresponding to a diagnostic test;
encoding the data into audio tones;
playing the audio tones in a manner than can be received by a mobile telephone; and
repeating playing the audio tones until an acknowledgement is received.

13. The method of example 12 wherein the audio tones are played via an audio port connectable to a mobile telephone.

14. The method of any of examples 12-13 wherein the acknowledgement comprises an audio tone.

15. The method of any of examples 12-14 wherein the audio tones corresponding to the encoded data comprise frequency key shifted audio tones having a different frequency for each different digit of the data.

16. The method of any of examples 12-15 and further comprising adding an error code to the data prior to encoding the data.

17. The method of example 16 and further comprising acknowledging receipt of the acknowledgement to a user, wherein the acknowledgement corresponds to successful receipt of the encoded data by a receiver as confirmed by the error code in the encoded data.

18. A method comprising:
receiving audio tones representative of encoded data corresponding to a value of a parameter sensed in a diagnostic test, wherein the encoded data includes an error code;
decoding the received audio tones into digits corresponding to the value of the sensed parameter;
applying the error code to check the validity of the decoded data; and
playing an acknowledgement tone when the decoded data is valid.

19. The method of example 18 wherein decoding the received audio tones includes performing a rolling FFT to extract the tone frequencies.

20. The method of any of examples 18-19 and further comprising sending a results message to a phone from which the audio tones were received.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device comprising:
a sensor to detect a parameter related to a diagnostic test;
a controller coupled to the sensor to receive sensed information from the sensor and generate binary data representative of the parameter; and
a tone generator to encode the binary data and provide audio tones to couple to a communication device.

2. The device of claim 1 wherein the audio tones are provided as electrical audio signals compatible with a microphone input of the wireless communication device comprising a cellular telephone.

3. The device of claim 1 wherein the sensor provides sensed information corresponding to an electrochemical test.

4. The device of claim 1 wherein the sensor comprises a glucose meter.

5. The device of claim 1 wherein the sensor comprises an optical sensor.

6. The device of claim 1 wherein the binary data comprises integer data, and wherein the tone generator generates a separate tone for each integer.

7. The device of claim 6 wherein the tone generator provides a header audio tone representative of the type of sensed data prior to sending a set of separate tones corresponding to each integer.

8. The device of claim 7 wherein the audio tones are repetitively sent with a delay between each repeated header and set of tones.

9. The device of claim 8 wherein the set of tones includes an error checking code.

10. The device of claim 9 wherein the controller is coupled to receive an acknowledgement code indicating that the set of tones was properly received, and to cease the sending of the set of tones.

11. The device of claim 9 wherein the error checking code comprises cyclical redundancy check code.

12. A method comprising:
receiving data representative of a parameter corresponding to a diagnostic test;
encoding the data into audio tones;
playing the audio tones in a manner than can be received by a mobile telephone; and
repeating playing the audio tones until an acknowledgement is received.

13. The method of claim 12 wherein the audio tones are played via an audio port connectable to a mobile telephone.

14. The method of claim 12 wherein the acknowledgement comprises an audio tone.

15. The method of claim 12 wherein the audio tones corresponding to the encoded data comprise frequency key shifted audio tones having a different frequency for each different digit of the data.

16. The method of claim 12 and further comprising adding an error code to the data prior to encoding the data.

17. The method of claim 16 and further comprising acknowledging receipt of the acknowledgement to a user, wherein the acknowledgement corresponds to successful receipt of the encoded data by a receiver as confirmed by the error code in the encoded data.

18. A method comprising:
receiving audio tones representative of encoded data corresponding to a value of a parameter sensed in a diagnostic test, wherein the encoded data includes an error code;
decoding the received audio tones into digits corresponding to the value of the sensed parameter;
applying the error code to check the validity of the decoded data; and
playing an acknowledgement tone when the decoded data is valid.

19. The method of claim 18 wherein decoding the received audio tones includes performing a rolling FFT to extract the tone frequencies.

20. The method of claim 18 and further comprising sending a results message to a phone from which the audio tones were received.
